(19) United States
(12) Patent Application Publication
(10) Pub. No.: US 2010/0077981 A1
(43) Pub. Date: Apr. 1, 2010

(54) INTAKE MANIFOLD

(76) Inventor: Anthony S. MAMO, Castaic, CA (US)

Correspondence Address: FOLEY & LARDNER, 555 South Flower Street, SUITE 3500, LOS ANGELES, CA, 90071-2411, US

(21) Appl. No.: 12/479,511

(22) Filed: Jun. 5, 2009

Related U.S. Application Data
(60) Provisional application No. 61/101,525, filed on Sep. 30, 2008.

(51) Int. Cl. F02M 35/10

(52) U.S. Cl. 123/184.21

(57) ABSTRACT

Embodiments of the invention are directed to an intake manifold configured to facilitate a greater and smoother flow of air and fuel to the cylinders of an engine and, therefore, to facilitate improved performance of the engine. According to further embodiments, the intake manifold is designed for use with automotive engines. According to particular embodiments, the intake manifold is designed for use in automobiles such as racing automobiles and/or automobiles employing carburetive engines. However, it is understood that embodiments of the invention are configured more generally for use in various automotive applications, including automobiles employing direct-injection engines.

### CROSS-REFERENCE TO RELATED APPLICATIONS

Embodiments of the present invention relate to U.S. Provisional Application Ser. No. 61/101,525, filed Sep. 30, 2009, entitled “INTAKE MANIFOLD,” the contents of which are incorporated by reference herein and is a basis for a claim of priority.

### BACKGROUND OF THE INVENTION

The present invention relates generally to the field of intake manifolds and, more particularly, automotive intake manifolds.

In an automotive environment, an intake manifold receives a mixture of air and fuel from a carburetor and supplies the mixture to the cylinders of an engine. In more detail, in the intake manifold, the mixture is directed through a central chamber (i.e., the plenum) and then through runners that are adjacent to the plenum. The runners extend from the plenum to intake ports of respective cylinders.

The amount of mechanical power produced by the engine corresponds to the amount of the air/fuel mixture that is directed to the cylinders by the intake manifold. That is—the larger the amount of air/fuel mixture that is directed to the cylinders, the larger the amount of mechanical power that is produced by the engine. To increase the amount of air/fuel mixture that is directed to the cylinders by the intake manifold, the flow (i.e., the rate of delivery) of the air/fuel mixture from the intake manifold to the cylinders should also be increased.

### SUMMARY OF THE INVENTION

Embodiments of the invention are directed to an intake manifold configured to facilitate a greater and smoother flow of air and fuel to the cylinders of an engine and, therefore, to facilitate improved performance of the engine. According to further embodiments, the intake manifold is designed for use with automotive engines. According to particular embodiments, the intake manifold is designed for use in automobiles such as racing automobiles and/or automobiles employing carburetive engines. However, it is understood that embodiments of the invention are configured more generally for use in various automotive applications, including automobiles employing direct-injection engines.

According to one embodiment, an intake manifold for receiving a gaseous material includes a main body defining an interior chamber and at least one wall protruding from the main body into the interior chamber. The main body includes a first end, and an opening located at the first end and opening into the interior chamber. The at least one wall comprises a thickened portion located in the interior chamber.

According to another embodiment, an intake manifold for receiving a gaseous material includes a main body defining an interior chamber and a plurality of first walls protruding from the main body into the interior chamber. The main body includes a first end, and an opening located at the first end and opening into the interior chamber. The interior chamber opens into each of a plurality of runners. Each of the first walls at least partially defines entries from the interior chamber to each of a corresponding pair of adjacent ones of the runners. The entries to the runners are configured to facilitate a laminar flow of the gaseous material from the interior chamber to the runners.

### BRIEF DESCRIPTION OF THE DRAWINGS

FIG. 1 shows a top view of an intake manifold according to one embodiment.

FIG. 2 shows a portion of the top view of the intake manifold of FIG. 1.

FIGS. 3, 4 and 5 show cutaway views of a runner dividing wall according to one embodiment.

FIGS. 6, 7, and 8 show cutaway views of a first plenum dividing wall according to one embodiment.

FIGS. 9, 10 and 11 show cutaway views of a second plenum dividing wall according to one embodiment.

FIG. 12 shows a cutaway view of a leading edge profile of a runner dividing wall according to one embodiment.

FIG. 13 shows a cutaway view of a leading edge profile of the first plenum dividing wall.

FIG. 14 shows a cutaway view of a leading edge profile of the second plenum dividing wall.

FIG. 15 shows lengths of runners of the intake manifold of FIG. 1.

FIGS. 16, 17 and 18 show cutaway views of runners and entries to the runners according to one embodiment.

### DETAILED DESCRIPTION

Embodiments of the invention are directed to an intake manifold configured to facilitate a greater and smoother flow of air and fuel to the cylinders of an engine and, therefore, to facilitate improved engine performance. According to certain embodiments, the intake manifold is designed for use with automotive engines. According to particular embodiments, the intake manifold is designed for use in automobiles such as racing automobiles and/or automobiles employing carburetors that supply a mixture of air and fuel to the intake manifold. However, it is understood that embodiments of the invention are configured more generally for use in various automotive applications, including automobiles employing direct injection engines.

According to one aspect of the invention, an intake manifold has one or more walls (i.e., a runner dividing wall) protruding from the main body of the manifold into the interior chamber of the manifold. A nose portion of each of such walls is located at (or near) the interior end of the wall. The thickness of this nose portion is greater than the thickness of other portions of the wall (e.g., portions of the wall located between the nose portion and the end portion that meets the main body of the manifold). The thickness of the nose portion is provided to improve a laminar flow of air and/or fuel from the interior chamber of the manifold to the cylinders of an engine. According to another aspect of the invention, the walls at least partially define respective entries from the interior chamber to two adjacent runners. The entries to the runners are configured to improve a laminar flow of air and/or fuel from the interior chamber to the runners. According to a further aspect, each of the entries to the runners is further defined by a second wall (i.e., a plenum dividing wall) adjacent to the corresponding runner dividing wall. According to yet a further aspect, each of the entries to the runners is further defined by the nose portion of the corresponding runner dividing wall. As described above, the thickness of the nose portion is greater than the thickness of other portions of the runner dividing wall (e.g., portions of the wall located between the nose portion and the end portion that meets the main body of the manifold).

In a direct-injection engine, the intake manifold delivers air (rather than a mixture of air and fuel) to the engine cylinders. Although embodiments of the invention may be applied towards direct-injection as well as more traditional (e.g., carburetive) engines, for ease of description, embodiments of the invention will be described in more detail below with reference to a more traditional engine that receives a mixture of air and fuel from the intake manifold.

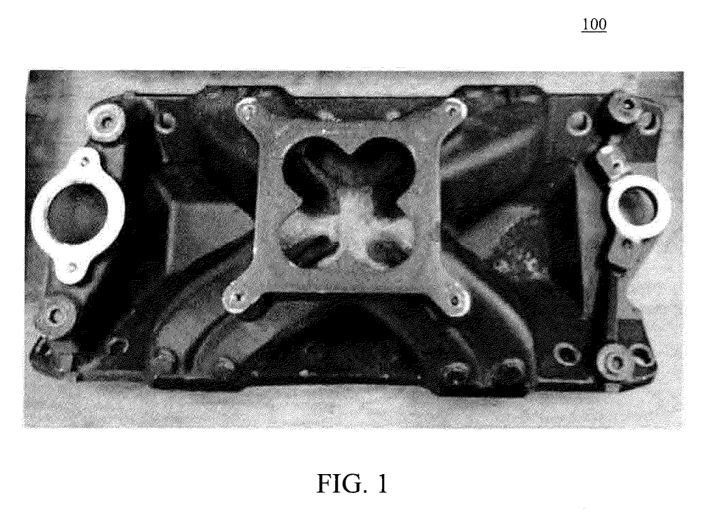

With reference to FIG. 1, according to one embodiment, the intake manifold 100 is a generally single-piece, integral structure. According to another embodiment, the intake manifold 100 is constructed from multiple pieces. According to one embodiment, the intake manifold is formed of a metal such as, but not limited to, aluminum and/or cast iron.

According to an exemplary embodiment, the intake manifold 100 is formed of a material that is able to maintain an internal temperature that is cooler than that maintained by a metal manifold. For example, the intake manifold may be formed of plastic, which has a lower level of thermal conductivity than metal. A plastic intake manifold is able to keep a mixture of air and fuel at a temperature cooler than that kept by a metal manifold. At such a cooler temperature, the density of air and fuel in the mixture is increased. Therefore, more of the air/fuel mixture is directed to the engine by the intake manifold. According to one estimate, a reduction in 10° Fahrenheit in the temperature of the mixture results in an increase of 1% in the mechanical power produced by the engine.

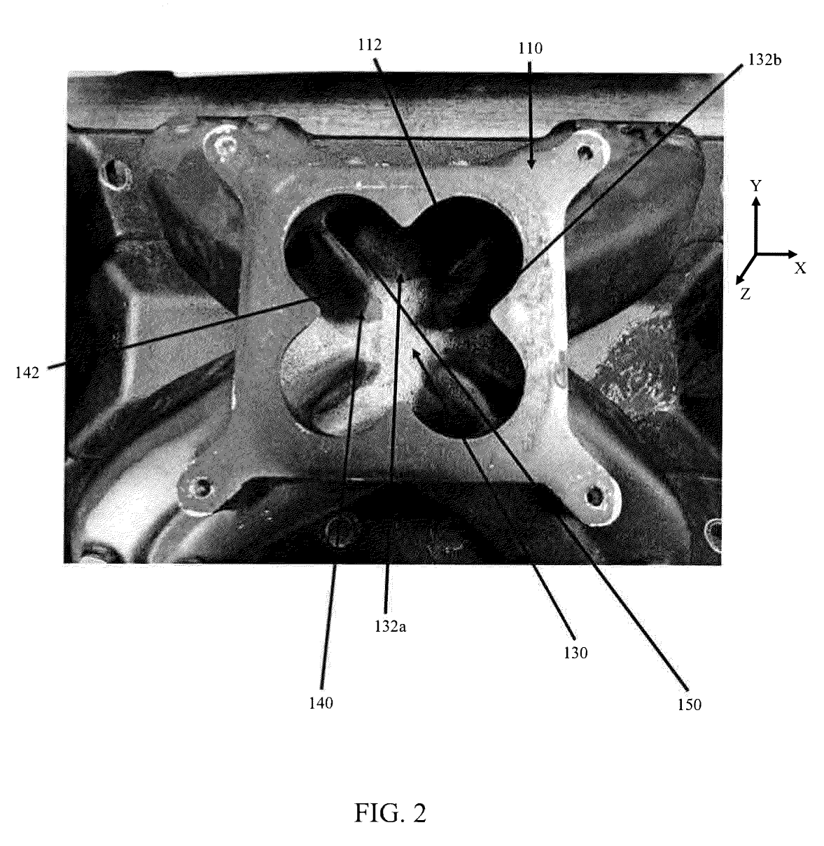

With reference to FIG. 2, a portion of the intake manifold 100 has a first end 110 and a second end 120 opposite the first end 110. According to one embodiment, the first end 110 is generally planar. In an automotive environment, the planar surface defined by the first end 110 may directly abut the carburetor.

With continued reference to FIG. 2, the first end 110 has one or more openings through which the mixture of air and fuel flows from the carburetor and into the intake manifold. According to one embodiment, the first end has a single opening 112 that is shaped generally in the form of a four-leaf clover. That is, the periphery of the opening 112 generally traces the outline of a four-leaf cover.

The opening 112 at the first end 110 leads to the plenum 130, which is a central inner chamber defined by the structure of the intake manifold. The floor of the plenum 130 is located at the second end 120 of the intake manifold. In embodiments having a clover-shaped opening at the first end 110, the plenum may be considered to include four connecting chambers, each chamber corresponding to one “leaf” of the clover. According to one embodiment, the chambers are roughly symmetrical with respect to one another.

Adjacent chambers share a plenum dividing wall 132a, 132b located between the chambers. Each of the chambers has a runner dividing wall 140 that extends along the z-direction (see FIG. 2) rising from the floor of the plenum 130 toward the opening 112. Along the xy-plane (see FIG. 2), the runner dividing wall 140 extends generally from the periphery of the opening 112 toward the center of the plenum 130. At (or near) the periphery of the opening 112, the runner dividing wall 140 marks the entrances to the runners 150.

The runners 150 are generally tunnel-shaped openings that lead from the plenum 130 to the cylinders of the engine. In the embodiment of FIGS. 1 and 2, the intake manifold has eight runners (or four pairs of runners) in total, with a runner dividing wall located between adjacent runners of each pair.

As will be explained in more detail below, the runner dividing wall 140 is configured to aid the flow of air/fuel into the engine cylinders via the runner 150.

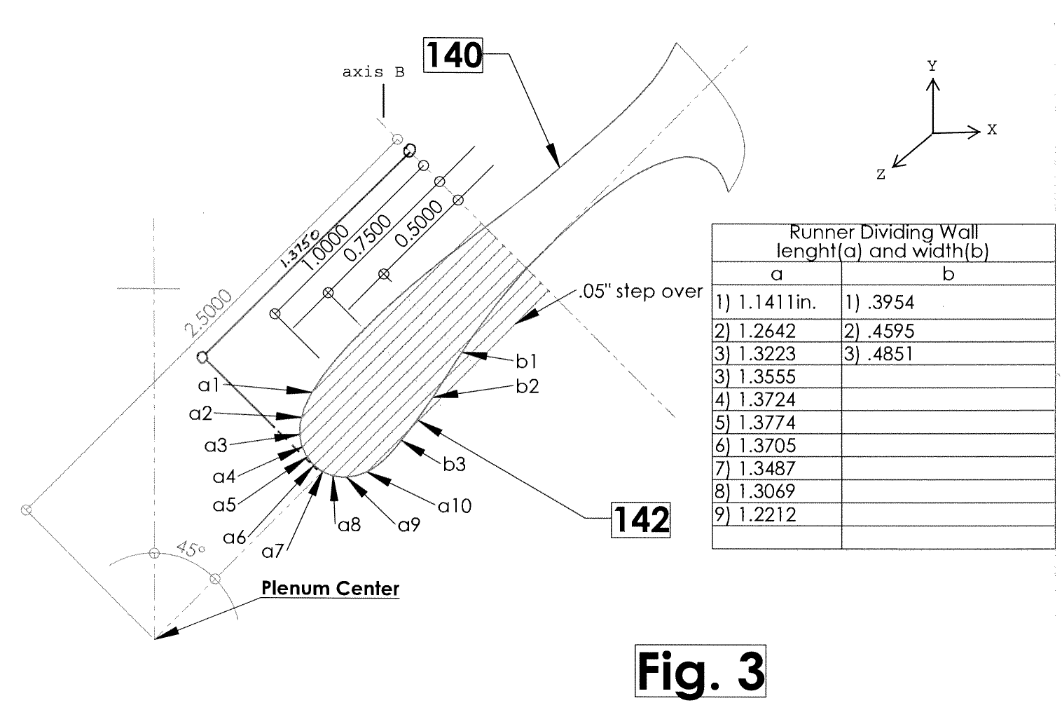

Near the center of the plenum, the runner dividing wall 140 has a “nose” 142 that extends along the z-direction (see FIG. 2). With reference to FIG. 3, the nose 142 has a generally bulbous shape (e.g., thicker and rounder at one end than the other). The nose 142 of the wall 140 has a thickness that is greater than the respective thicknesses of other portions of the runner dividing wall (e.g., portions nearest the opening 112 and the floor of the plenum 130 are thinner).

FIG. 3 is a cutaway view of a runner dividing wall 140 according to one embodiment. The view of FIG. 3 is taken at a distance (or depth) of 1.8 inches along the z-direction with respect to the opening 112 at the first end 110 of the intake manifold (see FIG. 2). With reference to FIG. 3, in the xy-plane, the thickness of runner dividing wall 140 generally increases along a direction leading away from the periphery of the plenum 130 and leading towards the center of the plenum 130. For example, with reference to FIG. 3, the thickness of the runner dividing wall 140 is represented by distances (in inches) measured at three representative locations along the above-described direction. At location b1, which is the farthest of the three locations from the center of the plenum 130 (and also the nearest of the three locations to the periphery of the plenum 130), the thickness of the runner dividing wall 140 is represented by the distance provided in the “b1” entry of the table shown in FIG. 3. The thickness increases to a thickness at the intermediate location b2 as represented by the distance provided in the “b2” entry of the table shown in FIG. 3. At location b3, which is the farthest of the three locations from the periphery of the plenum 130 (and also the nearest of the three locations to the center of the plenum 130), the thickness of the runner dividing wall 140 is represented by the distance provided in the “b3” entry of the table shown in FIG. 3.

Further, with continued reference to FIG. 3, the nose 142 of the runner dividing wall has a generally curved end. At column “a” of the table provided in FIG. 3, the distances (in inches) of points a1, a2, a3, a4, a5, a6, a7, a8, a9 and a10 of the curved end are provided with respect to axis B, which is located 2.5 inches away from the center of the plenum 130.

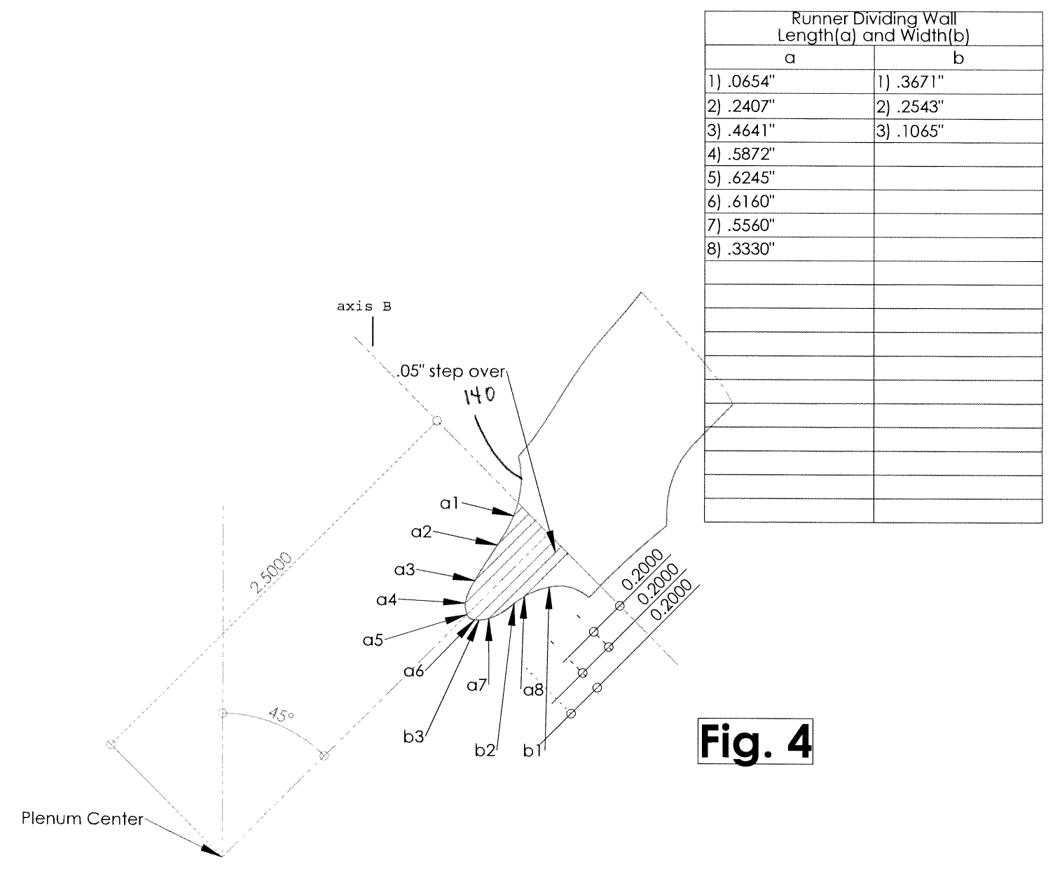

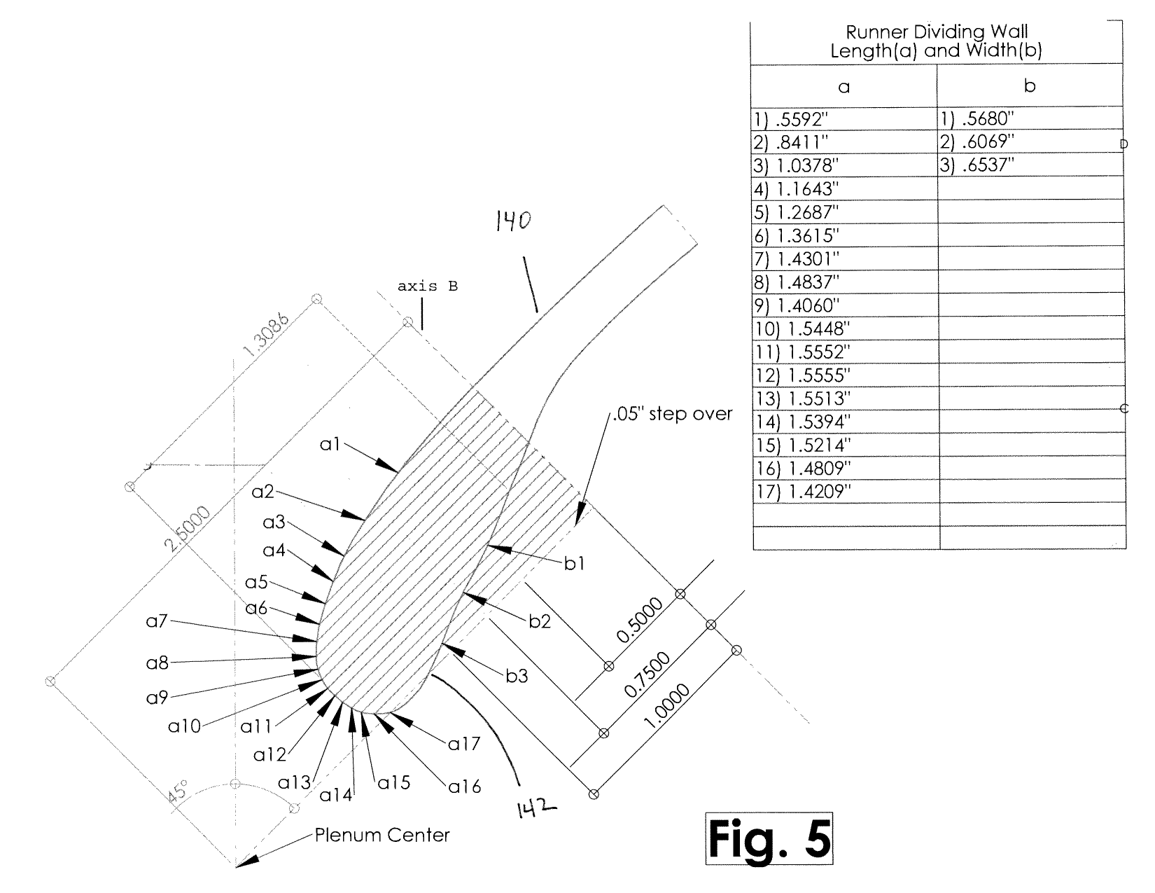

According to an exemplary embodiment, along the z-direction (see FIG. 2), the nose 142 extends along approximately 50-70% of the length of the runner dividing wall 140. That is—approximately 50-70% of the wall 140 has the thickness shown in FIG. 3. According to a further embodiment, the thickness of the nose 142 is generally constant with respect to the z-direction (see FIG. 2). The thickness of the nose 142 may taper to be thinner towards the floor of the plenum 130 and towards the clover-shaped opening 112. Exemplary thicknesses of these portions of the nose 142 (near the floor of the plenum and near the clover-shaped opening 112) are shown in the cutaway views of FIGS. 4 and 5.

The view of FIG. 4 is taken at a distance (or depth) of 1.0 inches along the z-direction with respect to the opening 112 at the first end 110 of the intake manifold (see FIG. 2). With reference to FIG. 4, in the xy-plane, the thickness of runner dividing wall 140 generally increases along a direction leading away from the periphery of the plenum 130 and leading towards the center of the plenum 130. For example, with reference to FIG. 4, the thickness of the runner dividing wall 140 is represented by distances (in inches) measured at three representative locations along the above-described direction. At location b1, which is the farthest of the three locations from the center of the plenum 130 (and also the nearest of the three locations to the periphery of the plenum 130), the thickness of the runner dividing wall 140 is represented by the distance provided in the “b1” entry of the table shown in FIG. 4. The thickness increases to a thickness at the intermediate location b2 as represented by the distance provided in the “b2” entry of the table shown in FIG. 4. At location b3, which is the farthest of the three locations from the periphery of the plenum 130 (and also the nearest of the three locations to the center of the plenum 130), the thickness of the runner dividing wall 140 is represented by the distance provided in the “b3” entry of the table shown in FIG. 4.

Further, with continued reference to FIG. 4, the nose 142 of the runner dividing wall has a generally curved end. At column “a” of the table provided in FIG. 4, the distances (in inches) of points a1, a2, a3, a4, a5, a6, a7 and a8 of the curved end are provided with respect to axis B, which is located 2.5 inches away from the center of the plenum 130.

The view of FIG. 5 is taken at a distance (or depth) of 3.6 inches along the z-direction with respect to the opening 112 at the first end 110 of the intake manifold (see FIG. 2). With reference to FIG. 5, in the xy-plane, the thickness of runner dividing wall 140 generally increases along a direction leading away from the periphery of the plenum 130 and leading towards the center of the plenum 130. For example, with reference to FIG. 5, the thickness of the runner dividing wall 140 is represented by distances (in inches) measured at three representative locations along the above-described direction. At location b1, which is the farthest of the three locations from the center of the plenum 130 (and also the nearest of the three locations to the periphery of the plenum 130), the thickness of the runner dividing wall 140 is represented by the distance provided in the “b1” entry of the table shown in FIG. 5. The thickness increases to a thickness at the intermediate location b2 as represented by the distance provided in the “b2” entry of the table shown in FIG. 5. At location b3, which is the farthest of the three locations from the periphery of the plenum 130 (and also the nearest of the three locations to the center of the plenum 130), the thickness of the runner dividing wall 140 is represented by the distance provided in the “b3” entry of the table shown in FIG. 5.

Further, with continued reference to FIG. 5, the nose 142 of the runner dividing wall has a generally curved end. At column “a” of the table provided in FIG. 4, the distances (in inches) of points a1, a2, a3, a4, a5, a6, a7, a8, a9, a10, a11, a12, a13, a14, a15, a16 and a17 of the curved end are provided with respect to axis B, which is located 2.5 inches away from the center of the plenum 130.

As will be described in more detail below, the increased thickness of the nose 142 facilitates improved laminar flow in the plenum 130 so that, in operation, there is less “shear.” As a result, the amount of air/fuel that flows into the runners 150 and to the cylinders may be increased, for example, by 3-5% relative to known manifolds.

Configuring the nose 142 of the runner dividing wall 140 to be thinner rather than thicker would take up less space in the plenum 130 and would therefore increase the capacity (i.e., free space) of the plenum 130. Conversely, increasing the thickness of the nose 142 would take up more space in the plenum 130 and would therefore reduce the capacity of the plenum 130. Based on these observations, one might conclude that reducing the capacity of the plenum 130 by configuring the runner dividing wall 140 to be thicker rather than thinner would reduce (a) the amount of air/fuel that can be contained in the intake manifold and therefore (b) the amount of air/fuel that can be supplied via the intake manifold to the intake cylinders.

Contrary to such conclusions, increasing the thickness correspondingly increases the flow of air/fuel from the intake manifold to the cylinders of the engine. The increased thickness improves the degree of laminar flow in the plenum 130, and therefore facilitates a smoother entry of the air/fuel mixture into the runners 150. In other words, the flow of the air/fuel mixture in the plenum 130 becomes more laminar and less turbulent. In contrast, configuring the walls 140 to be thinner would increase the degree of shear and therefore impede the flow of air/fuel into the runners 150.

For example, with reference to FIG. 3, an exemplary embodiment of the nose 142 is illustrated. The nose 142 of the runner dividing wall 140 corresponds generally to the portion of the wall 140 labeled as “b3.” With continued reference to FIG. 3, the “b3” portion of the wall is located approximately 0.375 inches away from the end of the wall 140 that is located nearest to the center of the plenum. In addition, the “b3” portion of the wall is located approximately 1.000 inches away from axis B that is located 2.5 inches away from the center of the plenum 130.

As illustrated in FIG. 3, the thickness of the wall 140 is largest at its nose. For example, the thickness of the wall at location “b3” is approximately 0.485 inches, which is greater than the thicknesses of other portions of the wall 140 illustrated in FIG. 3 (which, as previously described, illustrates the wall 140 at a depth of 1.8 inches along the z-direction with respect to the opening 112 at the first end 110 of the intake manifold (see FIG. 2)). Such other portions of the wall include the portions of the wall located between the portion of the wall 140 labeled as “b3” and the end of the wall located nearest to the center of the plenum. Such other portions of the wall include the portions labeled as “b1” and “b2,” which have thicknesses of approximately 0.395 inches and 0.460 inches respectively.

Similarly, as illustrated in FIG. 5, the thickness of the wall 140 is largest at its nose. For example, the thickness of the wall at location “b3” is approximately 0.654 inches, which is greater than the thicknesses of other portions of the wall 140 illustrated in FIG. 5 (which, as previously described, illustrates the wall 140 at a depth of 3.6 inches along the z-direction with respect to the opening 112 at the first end 110 of the intake manifold (see FIG. 2)). Such other portions of the wall include the portions of the wall located between the portion of the wall 140 labeled as “b3” and the end of the wall located nearest to the center of the plenum. Such other portions of the wall include the portions labeled as “b1” and “b2,” which have thicknesses of approximately 0.568 inches and 0.607 inches respectively

According to one embodiment, the thickness of the wall at portions “b1,” “b2,” and “b3” may be increased or decreased by approximately +/−25%. For example, regarding the measurements provided in FIG. 3, the wall may be configured to be thickened such that thicknesses of the wall from portion “b1” to the rounded end of the wall are increased. For example, the thicknesses at portions “b1,” “b2,” and “b3” may be increased to be as great as approximately 0.4943 inches, 0.5744 inches, and 0.6063 inches, respectively. As another example, the wall may be configured to be less thick such that thicknesses of the wall from portion “b1” to the rounded end of the wall are decreased. For example, the thicknesses at portions “b1,” “b2,” and “b3” may be decreased to be as low as approximately 0.2966 inches, 0.3446 inches, and 0.3638 inches, respectively. According to model calculations, it is estimated that configurations in the approximate ranges described above will provide an improved degree of laminar flow over known manifolds. For example, according to one embodiment, the thickness of the wall at portion “b3” may be increased or reduced by up to approximately 25% (i.e., without correspondingly increasing or reducing the thicknesses of the wall at portions “b1” and “b2”) to provide improved laminar flow. According to exemplary embodiments, the thickness of the wall at portion “b3” is increased or reduced by up to approximately 25%, and the thicknesses of the wall at other portions (e.g., including portions “b1” and “b2”) are increased or reduced accordingly.

Here, it may be useful for illustrative purposes to draw an analogy to the flow of air over an airplane wing. A thin “sheet” of air lying over the surface of the wing (and other surfaces of the airplane) is known as the boundary layer. Because air has viscosity, this layer of air tends to adhere to the wing. As the wing moves forward through the air, the boundary layer flows smoothly over the streamlined shape of the airfoil. Here the flow is generally laminar, and, as such, the boundary layer is a laminar layer. Aspects of the present invention are directed to facilitating the formation of a similar laminar layer of air/fuel at the nose 142 of the runner dividing wall 140.

With reference to embodiments of the invention (e.g., the embodiment of FIGS. 3, 4 and 5) the thickness of the nose 142 of the runner dividing walls 140 can be increased or decreased by up to approximately 25% (e.g., relative to the dimensions shown in FIGS. 3, 4, and 5), without significantly affecting the aspects described above (including, for example, improvement in degree of laminar flow in the plenum 130 and acceptable levels of shear).

The improvements in the flow of air/fuel from the intake manifold have been experimentally measured. For example, engine output was increased by 3% as tested on a 406 CID (cubic inch displacement) motor used as a baseline. The output of a 620 HP engine was increased to 640 HP when mated with an intake manifold that was constructed of aluminum. As such, these results were obtained by testing an intake manifold according to an embodiment of the invention that was primarily constructed of metal. As such, it is estimated that using an intake manifold formed primarily of a material such as plastic (which, as previously explained, would keep the air/fuel mixture inside the plenum at a lower temperature) would further improve these results.

According to one embodiment, the runner 150 has a length configured to facilitate a minimum RPM of the engine.

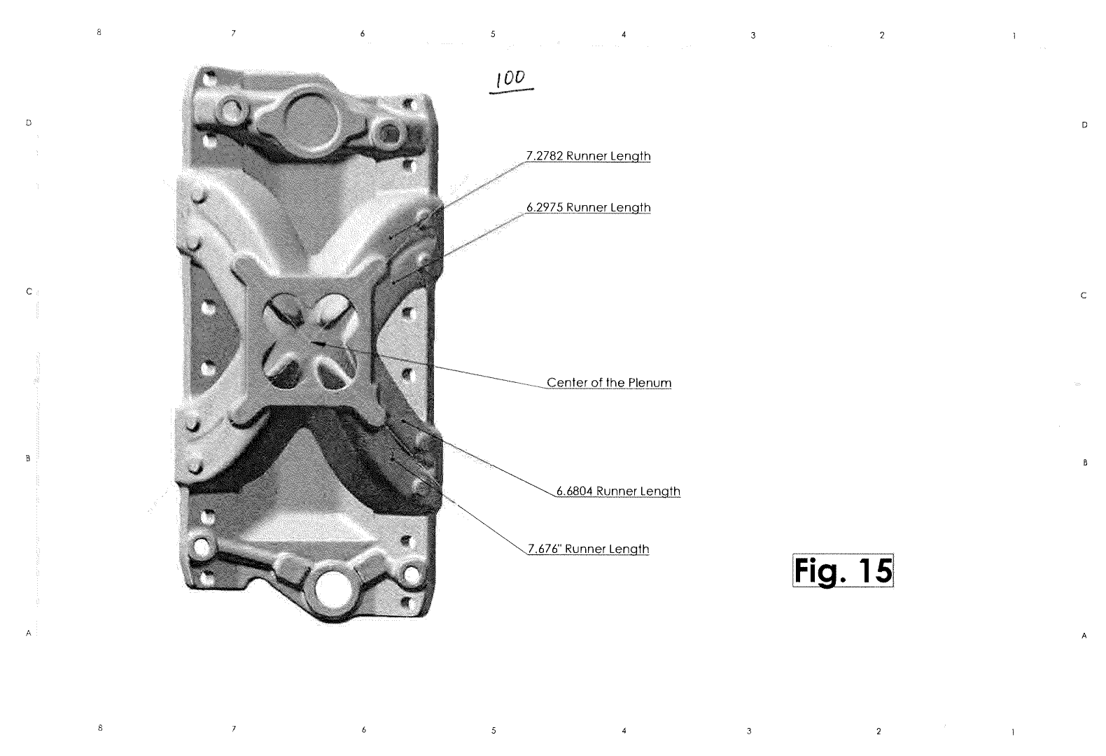

With reference to FIG. 15, representative lengths of runners of the manifold 100 (see, for example, FIG. 1) are shown. The length and the curvature of the runners are for producing an increased RPM by allowing the engine to better fill the intake cylinders. At the entry of the runner, the runner has leading edges that lead to the ports to the cylinder. The representative lengths are measured approximately from the center of the plenum to the end of the respective runner. The curvatures of the leading edges are also for providing a smoother entry and, therefore, for increasing the amount of air/fuel that is delivered to the cylinders.

The plenum dividing wall 132a, 132b also extends into the plenum 130. According to one embodiment, the plenum dividing wall 132a, 132b does not extend into the plenum 130 as much as the runner dividing wall 140 does (see, for example, FIG. 2).

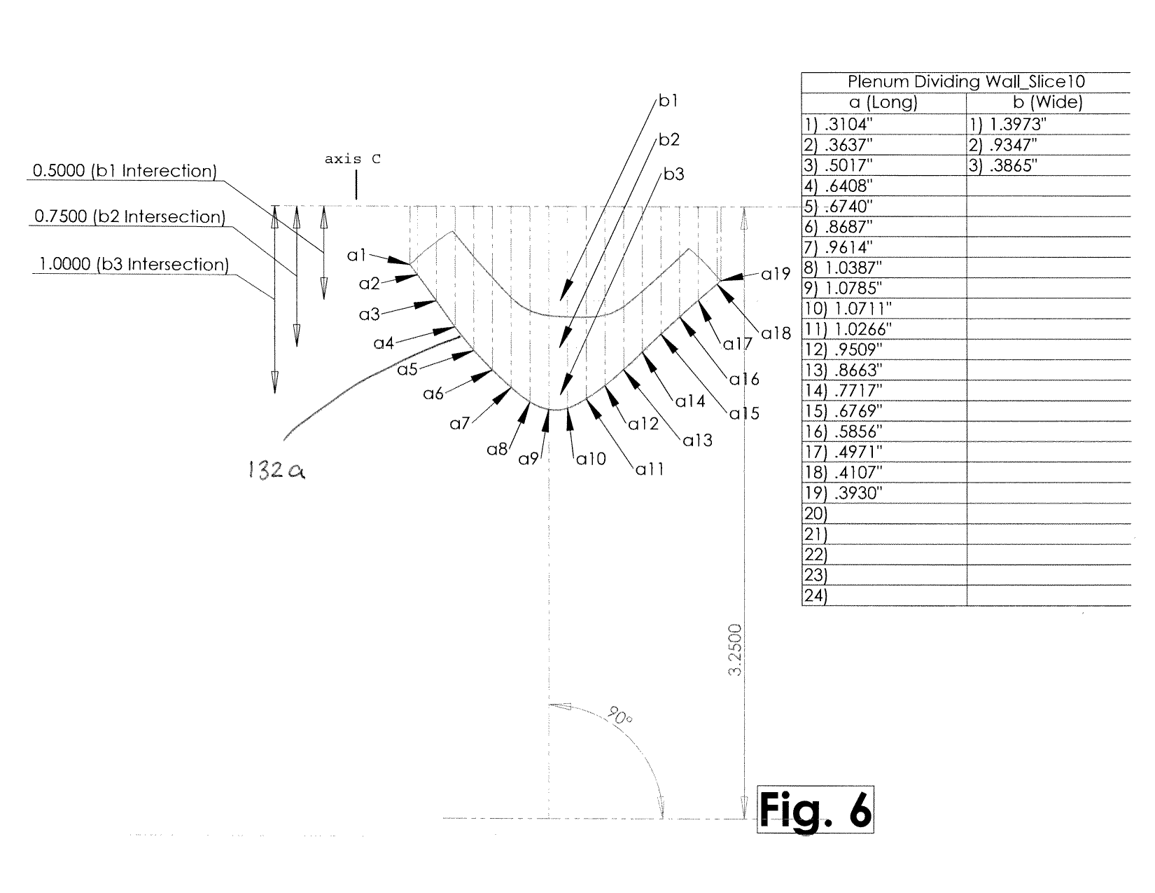

FIG. 6 is a cutaway view of a plenum dividing wall 132a according to one embodiment. The view of FIG. 6 is taken at a distance (or depth) of 1.8 inches along the z-direction with respect to the opening 112 at the first end 110 of the intake manifold (see FIG. 2). With reference to FIG. 6, in the xy-plane, the thickness of plenum dividing wall 132a generally decreases along a direction leading away from the periphery of the plenum 130 and leading towards the center of the plenum 130. For example, with reference to FIG. 6, the thickness of the plenum dividing wall 132a is represented by distances (in inches) measured at three representative locations along the above-described direction. At location b1, which is the farthest of the three locations from the center of the plenum 130 (and also the nearest of the three locations to the periphery of the plenum 130), the thickness of the plenum dividing wall 132a is represented by the distance provided in the “b1” entry of the table shown in FIG. 6. The thickness decreases to a thickness at the intermediate location b2 as represented by the distance provided in the “b2” entry of the table shown in FIG. 6. At location b3, which is the farthest of the three locations from the periphery of the plenum 130 (and also the nearest of the three locations to the center of the plenum 130), the thickness of the plenum dividing wall 132a is represented by the distance provided in the “b3” entry of the table shown in FIG. 6.

Further, with continued reference to FIG. 6, the plenum dividing wall 132a has a generally curved shape. At column “a” of the table provided in FIG. 6, the distances (in inches) of points a1, a2, a3, a4, a5, a6, a7, a8, a9, a10, a11, a12, a13, a14, a15, a16, a17, a18 and a19 of the curved shape are provided with respect to axis C, which is located 3.25 inches away from the center of the plenum 130.

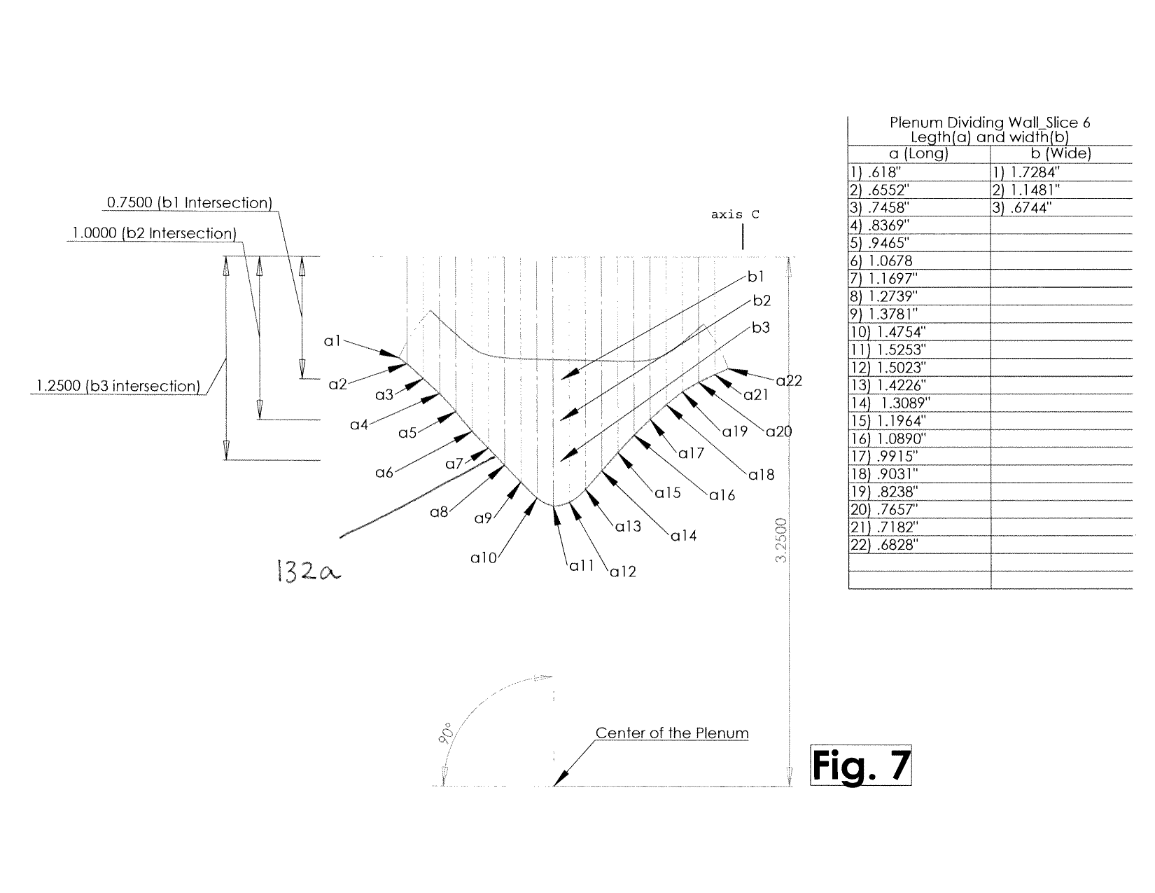

FIG. 7 is a cutaway view of the plenum dividing wall 132a according to one embodiment. The view of FIG. 7 is taken at a distance (or depth) of 1.0 inches along the z-direction with respect to the opening 112 at the first end 110 of the intake manifold (see FIG. 2). With reference to FIG. 7, in the xy-plane, the thickness of plenum dividing wall 132a generally decreases along a direction leading away from the periphery of the plenum 130 and leading towards the center of the plenum 130. For example, with reference to FIG. 7, the thickness of the plenum dividing wall 132a is represented by distances (in inches) measured at three representative locations along the above-described direction. At location b1, which is the farthest of the three locations from the center of the plenum 130 (and also the nearest of the three locations to the periphery of the plenum 130), the thickness of the plenum dividing wall 132a is represented by the distance provided in the “b1” entry of the table shown in FIG. 7. The thickness decreases to a thickness at the intermediate location b2 as represented by the distance provided in the “b2” entry of the table shown in FIG. 7. At location b3, which is the farthest of the three locations from the periphery of the plenum 130 (and also the nearest of the three locations to the center of the plenum 130), the thickness of the plenum dividing wall 132a is represented by the distance provided in the “b3” entry of the table shown in FIG. 7.

Further, with continued reference to FIG. 7, the plenum dividing wall 132a has a generally curved shape. At column “a” of the table provided in FIG. 7, the distances (in inches) of points a1, a2, a3, a4, a5, a6, a7, a8, a9, a10, a11, a12, a13, a14, a15, a16, a17, a18, a19, a20, a21 and a22 of the curved shape are provided with respect to axis C, which is located 3.25 inches away from the center of the plenum 130.

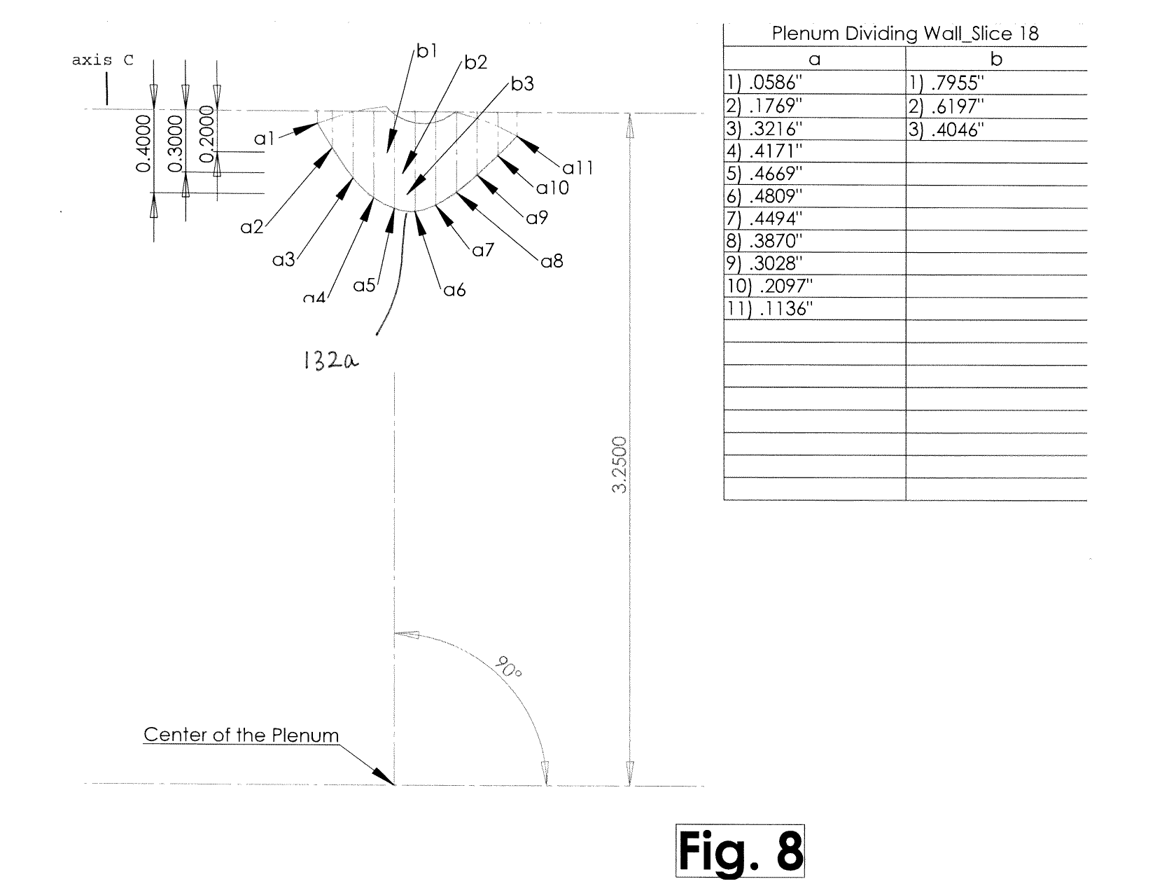

FIG. 8 is a cutaway view of the plenum dividing wall 132a according to one embodiment. The view of FIG. 8 is taken at a distance (or depth) of 3.4 inches along the z-direction with respect to the opening 112 at the first end 110 of the intake manifold (see FIG. 2). With reference to FIG. 8, in the xy-plane, the thickness of plenum dividing wall 132a generally decreases along a direction leading away from the periphery of the plenum 130 and leading towards the center of the plenum 130. For example, with reference to FIG. 8, the thickness of the plenum dividing wall 132a is represented by distances (in inches) measured at three representative locations along the above-described direction. At location b1, which is the farthest of the three locations from the center of the plenum 130 (and also the nearest of the three locations to the periphery of the plenum 130), the thickness of the plenum dividing wall 132a is represented by the distance provided in the “b1” entry of the table shown in FIG. 8. The thickness decreases to a thickness at the intermediate location b2 as represented by the distance provided in the “b2” entry of the table shown in FIG. 8. At location b3, which is the farthest of the three locations from the periphery of the plenum 130 (and also the nearest of the three locations to the center of the plenum 130), the thickness of the plenum dividing wall 132a is represented by the distance provided in the “b3” entry of the table shown in FIG. 8.

Further, with continued reference to FIG. 8, the plenum dividing wall 132a has a generally curved shape. At column “a” of the table provided in FIG. 8, the distances (in inches) of points a1, a2, a3, a4, a5, a6, a7, a8, a9, a10 and a11 of the curved shape are provided with respect to axis C, which is located 3.25 inches away from the center of the plenum 130.

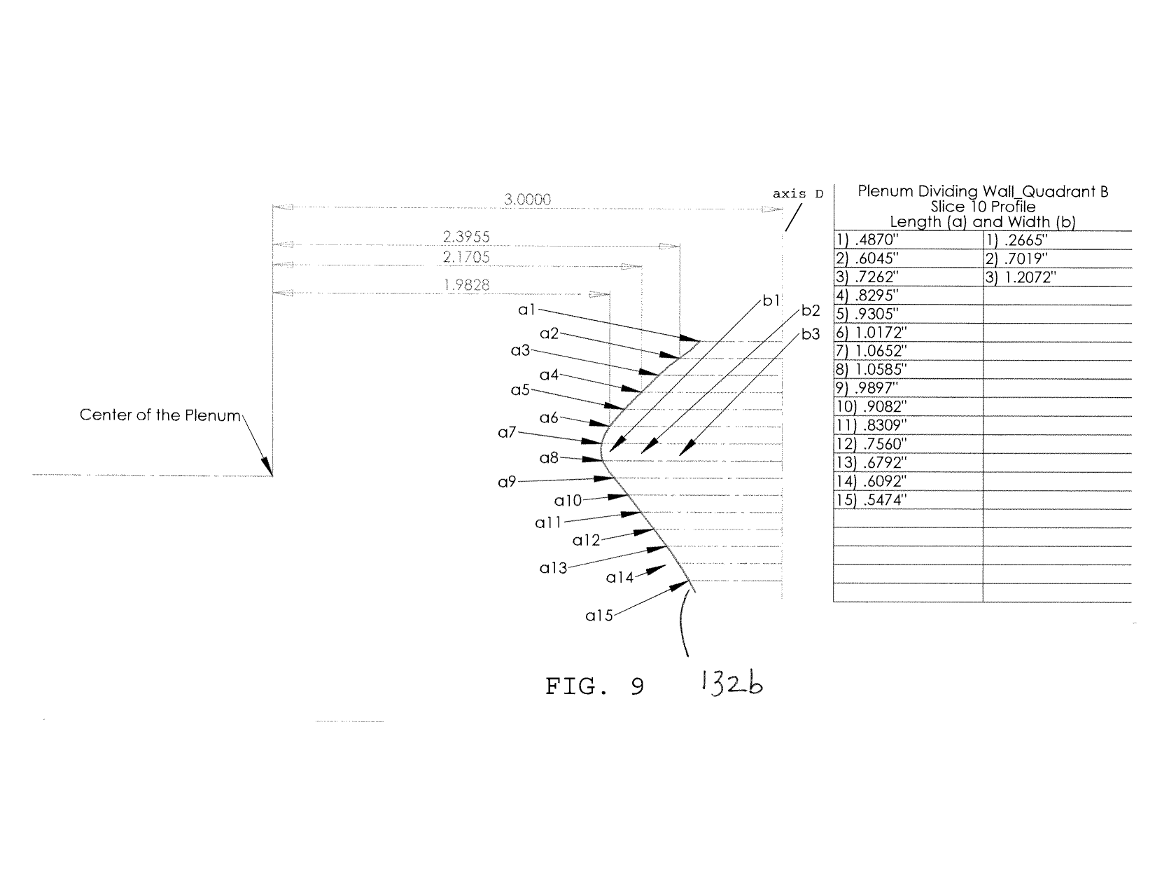

FIG. 9 is a cutaway view of a plenum dividing wall 132b according to one embodiment. The view of FIG. 9 is taken at a distance (or depth) of 1.8 inches along the z-direction with respect to the opening 112 at the first end 110 of the intake manifold (see FIG. 2). With reference to FIG. 9, in the xy-plane, the thickness of plenum dividing wall 132b generally decreases along a direction leading away from the periphery of the plenum 130 and leading towards the center of the plenum 130. For example, with reference to FIG. 9, the thickness of the plenum dividing wall 132b is represented by distances (in inches) measured at three representative locations along the above-described direction. At location b3, which is the farthest of the three locations from the center of the plenum 130 (and also the nearest of the three locations to the periphery of the plenum 130), the thickness of the plenum dividing wall 132b is represented by the distance provided in the “b3” entry of the table shown in FIG. 9. The thickness decreases to a thickness at the intermediate location b2 as represented by the distance provided in the “b2” entry of the table shown in FIG. 9. At location b1, which is the farthest of the three locations from the periphery of the plenum 130 (and also the nearest of the three locations to the center of the plenum 130), the thickness of the plenum dividing wall 132b is represented by the distance provided in the “b1” entry of the table shown in FIG. 9.

Further, with continued reference to FIG. 9, the plenum dividing wall 132b has a generally curved shape. At column “a” of the table provided in FIG. 9, the distances (in inches) of points a1, a2, a3, a4, a5, a6, a7, a8, a9, a10, a11, a12, a13, a14 and a15 of the curved shape are provided with respect to axis D, which is located 3.0 inches away from the center of the plenum 130.

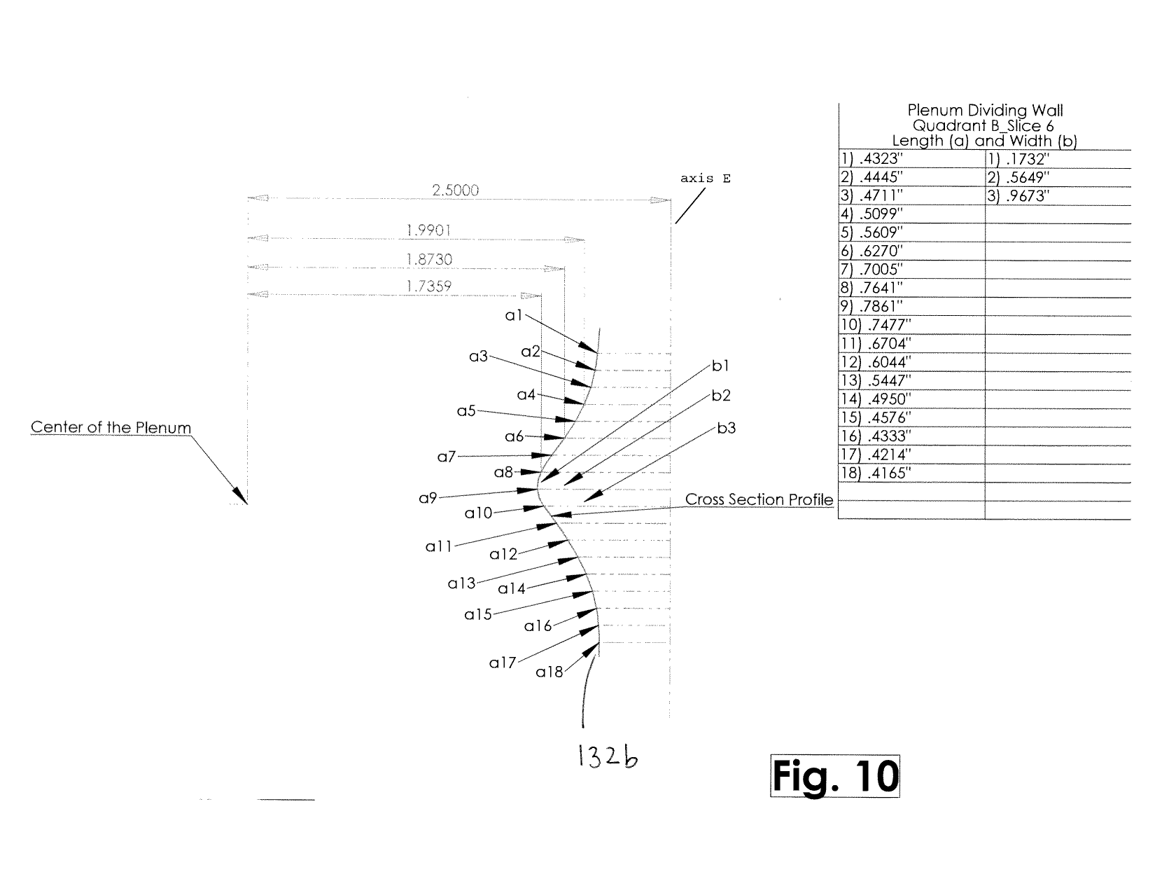

FIG. 10 is a cutaway view of the plenum dividing wall 132b according to one embodiment. The view of FIG. 10 is taken at a distance (or depth) of 1.0 inches along the z-direction with respect to the opening 112 at the first end 110 of the intake manifold (see FIG. 2). With reference to FIG. 10, in the xy-plane, the thickness of plenum dividing wall 132b generally decreases along a direction leading away from the periphery of the plenum 130 and leading towards the center of the plenum 130. For example, with reference to FIG. 10, the thickness of the plenum dividing wall 132b is represented by distances (in inches) measured at three representative locations along the above-described direction. At location b3, which is the farthest of the three locations from the center of the plenum 130 (and also the nearest of the three locations to the periphery of the plenum 130), the thickness of the plenum dividing wall 132b is represented by the distance provided in the “b3” entry of the table shown in FIG. 10. The thickness decreases to a thickness at the intermediate location b2 as represented by the distance provided in the “b2” entry of the table shown in FIG. 10. At location b1, which is the farthest of the three locations from the periphery of the plenum 130 (and also the nearest of the three locations to the center of the plenum 130), the thickness of the plenum dividing wall 132b is represented by the distance provided in the “b1” entry of the table shown in FIG. 10.

Further, with continued reference to FIG. 10, the plenum dividing wall 132b has a generally curved shape. At column “a” of the table provided in FIG. 10, the distances (in inches) of points a1, a2, a3, a4, a5, a6, a7, a8, a9, a10, a11, a12, a13, a14, a15, a16, a17 and a18 of the curved shape are provided with respect to axis E, which is located 2.5 inches away from the center of the plenum 130.

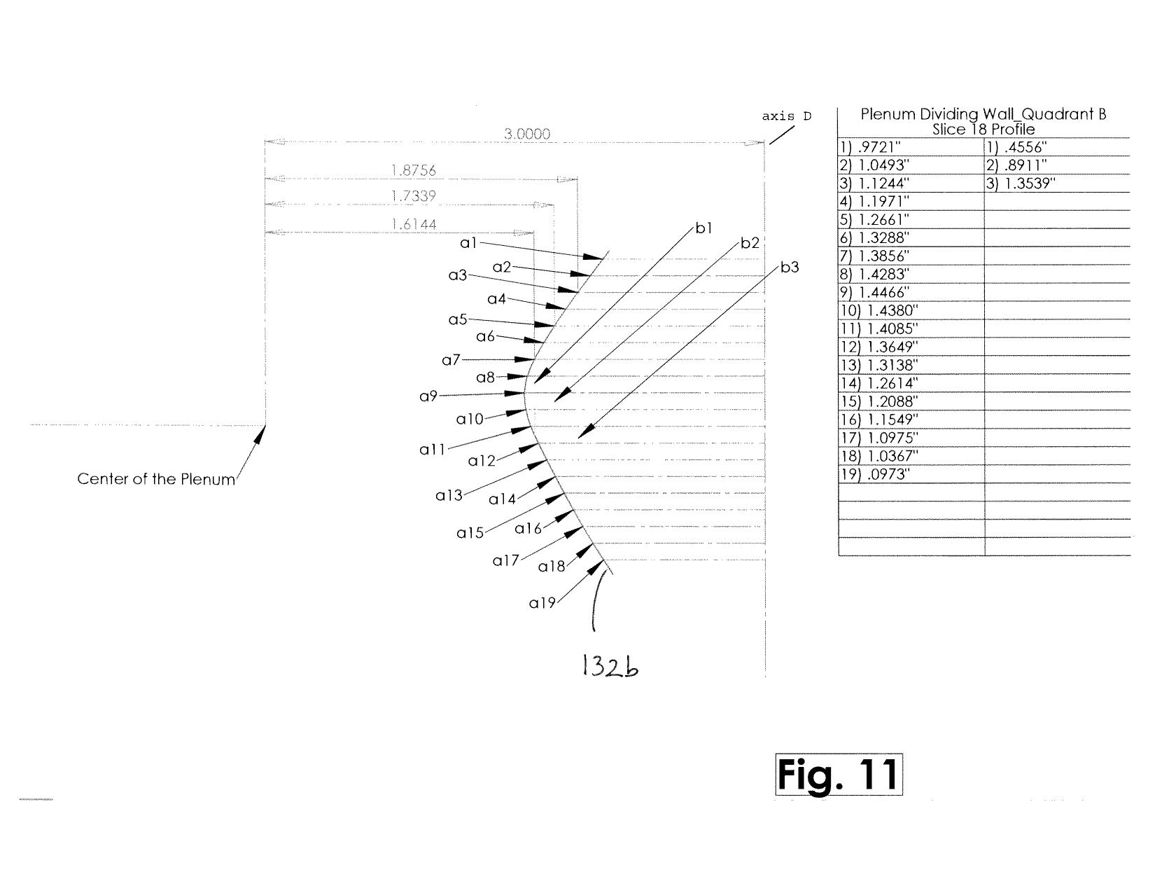

FIG. 11 is a cutaway view of the plenum dividing wall 132b according to one embodiment. The view of FIG. 11 is taken at a distance (or depth) of 3.4 inches along the z-direction with respect to the opening 112 at the first end 110 of the intake manifold (see FIG. 2). With reference to FIG. 11, in the xy-plane, the thickness of plenum dividing wall 132b generally decreases along a direction leading away from the periphery of the plenum 130 and leading towards the center of the plenum 130. For example, with reference to FIG. 11, the thickness of the plenum dividing wall 132b is represented by distances (in inches) measured at three representative locations along the above-described direction. At location b3, which is the farthest of the three locations from the center of the plenum 130 (and also the nearest of the three locations to the periphery of the plenum 130), the thickness of the plenum dividing wall 132b is represented by the distance provided in the “b3” entry of the table shown in FIG. 11. The thickness decreases to a thickness at the intermediate location b2 as represented by the distance provided in the “b2” entry of the table shown in FIG. 11. At location b1, which is the farthest of the three locations from the periphery of the plenum 130 (and also the nearest of the three locations to the center of the plenum 130), the thickness of the plenum dividing wall 132b is represented by the distance provided in the “b1” entry of the table shown in FIG. 11.

Further, with continued reference to FIG. 11, the plenum dividing wall 132b has a generally curved shape. At column “a” of the table provided in FIG. 11, the distances (in inches) of points a1, a2, a3, a4, a5, a6, a7, a8, a9, a10, a11, a12, a13, a14, a15, a16, a17, a18 and a19 of the curved shape are provided with respect to axis D, which is located 3.0 inches away from the center of the plenum 130.

One advantage of this plenum dividing wall configuration is to allow a smoother and more laminar flow of air into each pair of runners, ultimately allowing more air and fuel to enter the runners due to the reduction (or absence) of turbulence. Together with the runner dividing wall 140, the plenum dividing wall 132a, 132b defines the entry to the runner 150. As described earlier, the entry of the runner 150 is designed to facilitate a greater and smoother flow of air/fuel through the runners 150 and to the cylinders of the engine.

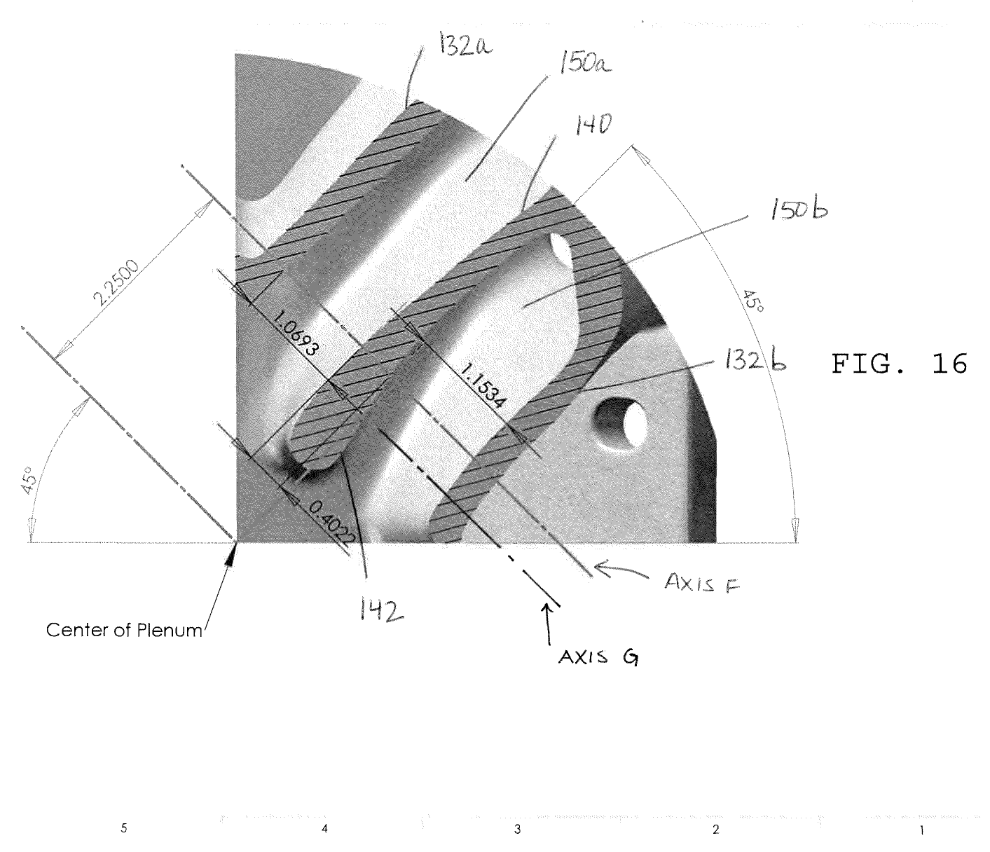

FIGS. 16, 17 and 18 are cutaway views of runners 150a and 150b according to one embodiment (including, for example, the embodiment of FIG. 3). The view of FIG. 16 is taken at a distance (or depth) of 2.4 inches along the z-direction with respect to the opening 112 at the first end 110 of the intake manifold (see FIG. 2). Runner 150a and the entry to the runner are defined by runner dividing wall 140, nose 142, and plenum dividing wall 132a. Similarly, runner 150b and the entry to the runner are defined by runner dividing wall 140, nose 142, and plenum dividing wall 132b. With continued reference to FIG. 16, in the xy-plane, respective widths (in inches) of the runners 150a, 150b are provided.

With reference to FIG. 16, along Axis F, which is located 2.25 inches away from the center of the plenum, the peripheries of the runner dividing wall 140 and the plenum dividing wall 132a are spaced apart by approximately 1.0693 inches to define the corresponding entry to the runner 150a. Along Axis F, the peripheries of the runner dividing wall 140 and the plenum dividing wall 132b are spaced apart by approximately 1.1534 inches to define the corresponding entry to the runner 150b. According to a further embodiment, the further definition of the entries to the runners 150a and 150b by the nose 142 (as described earlier, for example, with reference to FIG. 3) facilitates a greater and smoother flow of air/fuel from the plenum to the runners. In more detail, the thickening of the nose 142 creates a narrowing (or “throttling”) of the width of the runner 150b, e.g., with reference to FIG. 16, in a planar direction leading away from Axis F and leading to Axis G. The narrowing of the width of the runner 150b facilitates improvements in the degree of laminar flow in the runner 150b. Similarly, according to a further embodiment, the thickening of the nose 142 may create a narrowing (or throttling) of the width of the runner 150a, e.g., with reference to FIG. 16, in a planar direction leading away from Axis F and leading to Axis G. The narrowing of the width of the runner 150a facilitates improvements in the degree of laminar flow in the runner 150a.

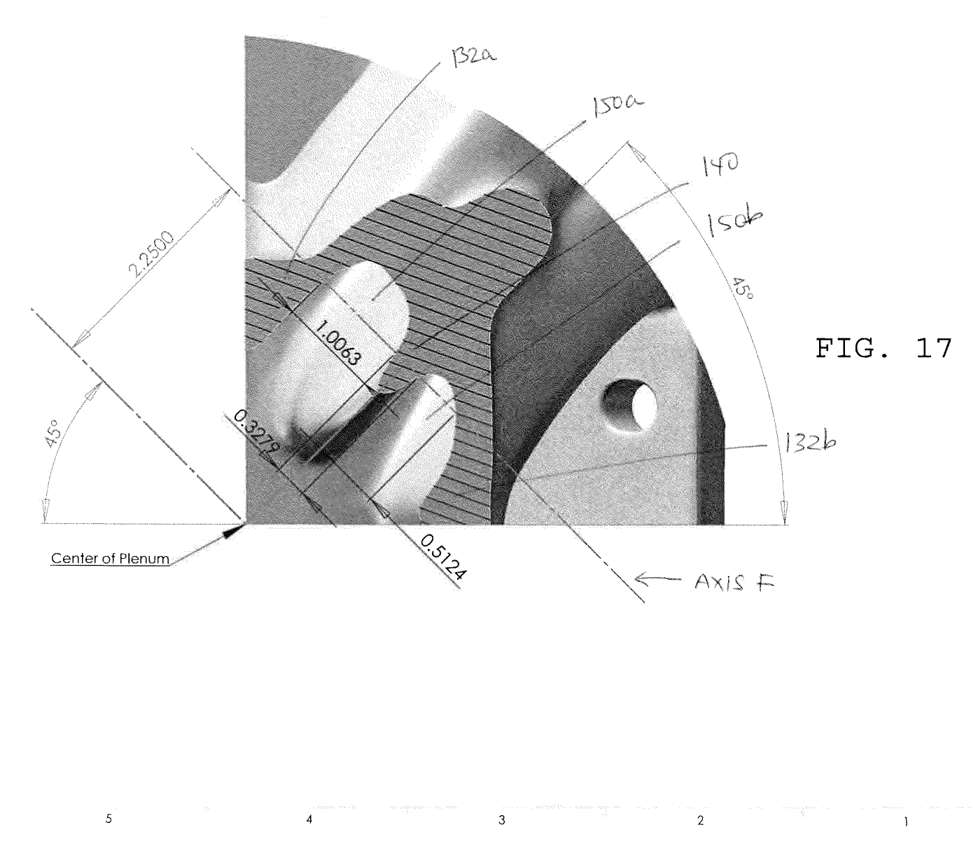

The view of FIG. 17 is taken at a distance (or depth) of 1.0 inches along the z-direction with respect to the opening 112 at the first end 110 of the intake manifold (see FIG. 2). Here, at this depth in the embodiment depicted, the runners are not yet fully defined. However, distances between the runner dividing wall 140 and the plenum dividing wall 132a and between the runner dividing wall 140 and the plenum dividing wall 132b are provided.

With reference to FIG. 17, along Axis F, which is located 2.25 inches away from the center of the plenum, the peripheries of the runner dividing wall 140 and the plenum dividing wall 132a are spaced apart by approximately 1.0063 inches. Along Axis F, the peripheries of the runner dividing wall 140 and the plenum dividing wall 132b are spaced apart by approximately 0.5124 inches.

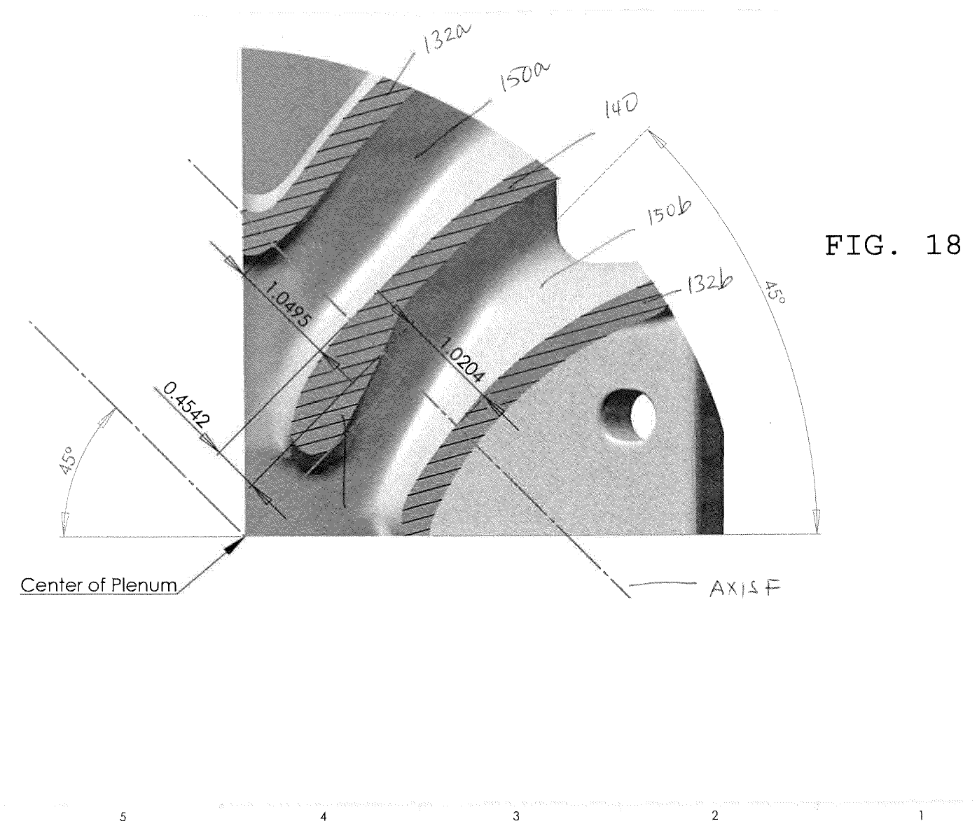

The view of FIG. 18 is taken at a distance (or depth) of 3.4 inches along the z-direction with respect to the opening 112 at the first end 110 of the intake manifold (see FIG. 2). Similar to the view of FIG. 16, in the xy-plane of FIG. 18, respective widths (in inches) of the runners 150a, 150b are provided.

With reference to FIG. 18, along Axis F, which is located 2.25 inches away from the center of the plenum, the peripheries of the runner dividing wall 140 and the plenum dividing wall 132a are spaced apart by approximately 1.0495 inches to define the corresponding entry to the runner 150a. Along Axis F, the peripheries of the runner dividing wall 140 and the plenum dividing wall 132b are spaced apart by approximately 1.0204 inches to define the corresponding entry to the runner 150b. As described earlier, for example, with reference to FIG. 3, a further definition of the entries to the runners 150a and 150b by the nose 142 facilitates a greater and smoother flow of air/fuel from the plenum to the runners.

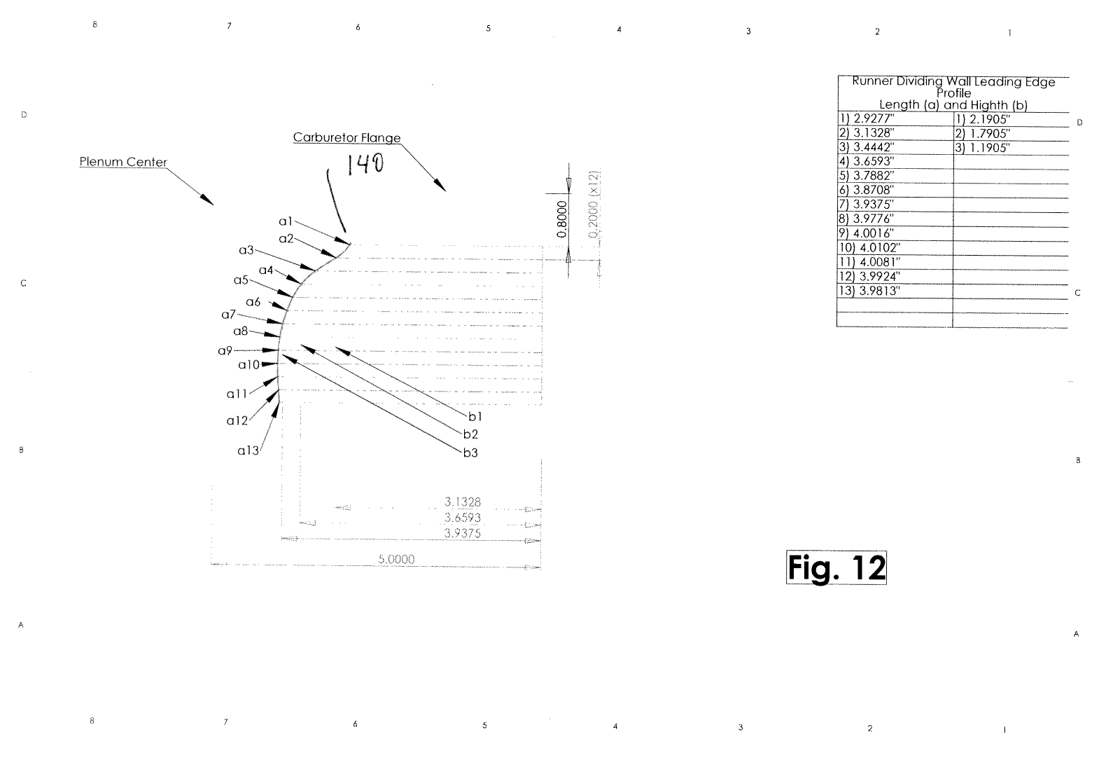

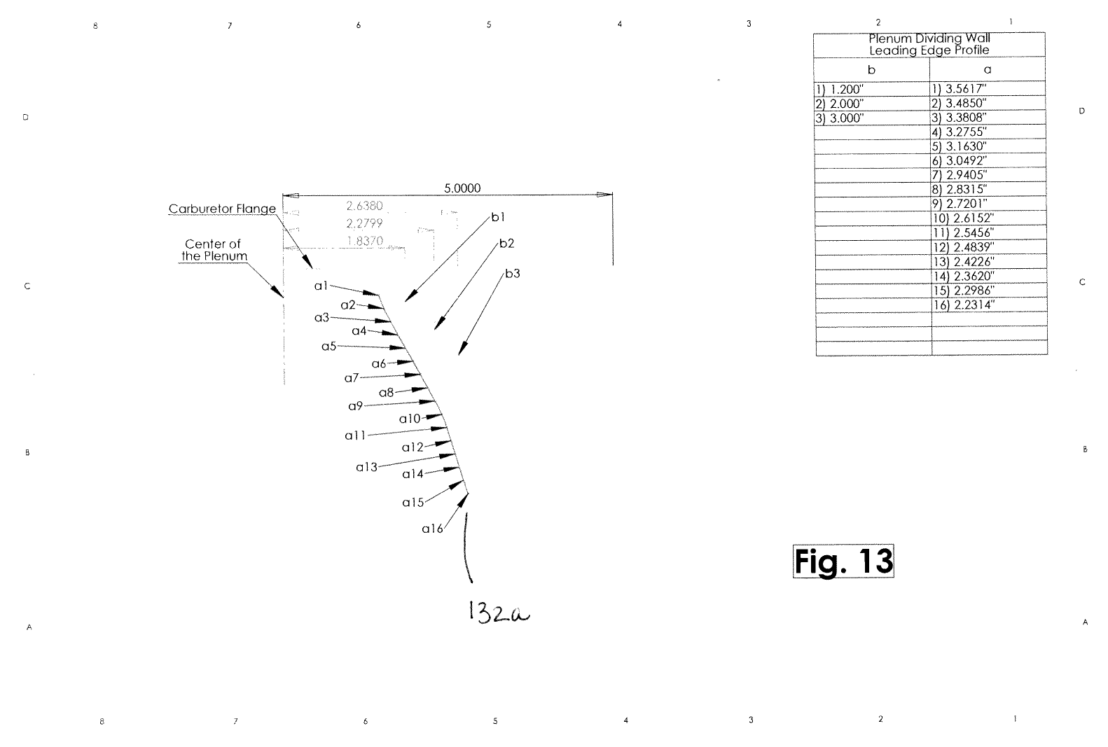

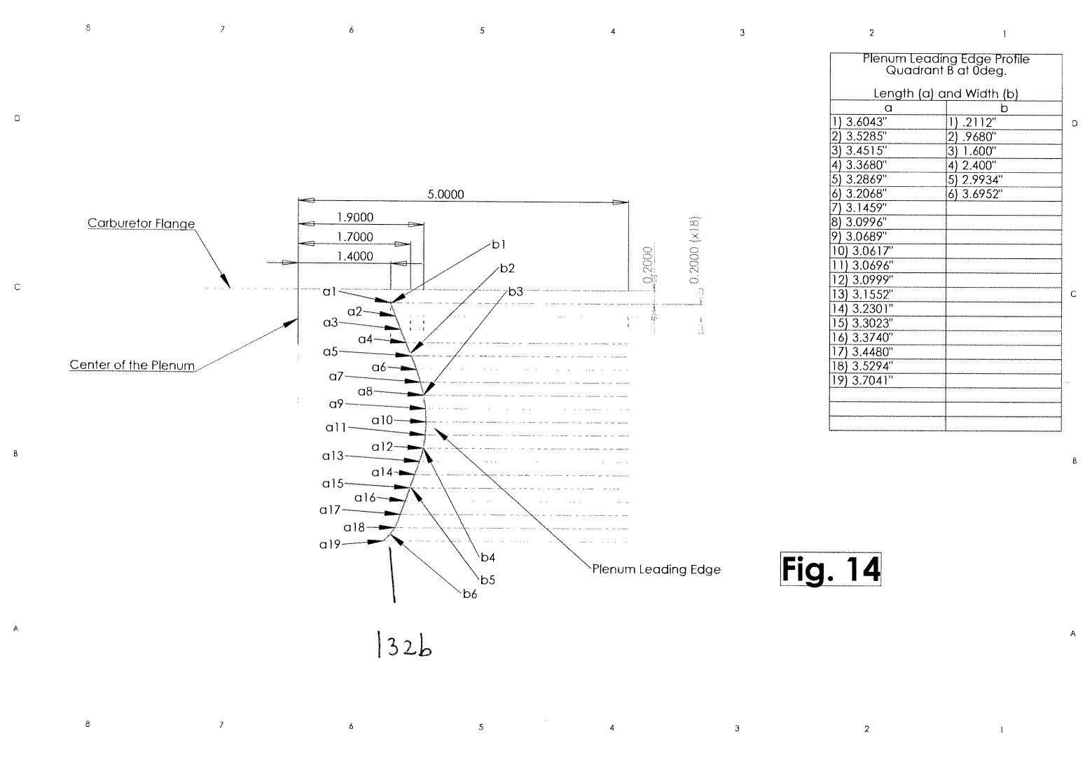

FIG. 12 shows a side profile of the runner dividing wall along the z-direction (see, for example, FIG. 2). Similarly, FIG. 13 shows a side profile of the plenum dividing wall 132a along the z-direction (see, for example, FIG. 2). Similarly, FIG. 14 shows a side profile of the plenum dividing wall 132b along the z-direction (see, for example, FIG. 2).

In operation, a mixture of air and fuel flows from the carburetor to the intake manifold through the opening 112. This mixture flows from the first end 110 of the intake manifold and into the plenum 130 toward the second end 120 of the manifold. The runner dividing wall 140 facilitates a laminar flow of the air/fuel mixture from the plenum 130 towards the runner 150. As such, the mixture flows more smoothly from the plenum 130 into the runner 150 and towards the intake cylinder for subsequent combustion at an engine.

According to some embodiments, the floor of the plenum (i.e., located at the second end 120 of the intake manifold) is generally level. However, according to a further embodiment, the floor of the plenum 130 has a protruding member—i.e., a raised dome-shaped portion. According to an exemplary embodiment, the protruding member is located at (or near) the center of the floor of the plenum 130. Although the protruding member may have the shape of a dome, it is understood that the protruding member may have various other suitable shapes such as (but not limited to) a pyramid-like structure. The protruding member is for increasing laminar flow (i.e., reducing the amount of “dead air” in the plenum 130). As such, the inclusion of the protruding member also aids the flow of air/fuel from the plenum 130 and into the runners 150. According to an estimate in one application, the inclusion of the protruding member results in a mechanical power increase of 2 HP.

According to described embodiments, the intake manifold is developed for use with small-block engines covering a range of displacements ranging, for example, from approximately 4.6 liters to 6.5 liters. Examples of such small-block engines include, but are not limited to, Gen1 and Gen2 small-block Chevrolet engines.

According to one embodiment, the intake manifold abuts the carburetor. According to another embodiment, a spacer is positioned in between the carburetor and the intake manifold, i.e., in between the carburetor and the first end of the intake manifold. The placement of the spacer effectively increases the volume of the plenum of the intake manifold (but without reducing the degree of laminar flow in the plenum). As such, the inclusion of the spacer increases the amount of air/fuel mixture that may be directed by the intake manifold to the engine cylinders. The spacer may also have a clover-shaped opening extending through the top and bottom ends of the spacer, along the depth dimension. This opening is shaped and sized to match the clover-shaped opening of the manifold. As previously described, the spacer is for increasing the effective volume of the plenum of the manifold, when mated with the spacer. It is removably mated with the manifold, and it is to be used in applications where sufficient room for placement of the spacer is provided (e.g., in automobiles in which there is sufficient room under the hood).

It should be understood that various modifications may be made to the embodiments disclosed herein. Therefore, the above description should not be construed as limiting, but merely as exemplification of the various embodiments. Those skilled in the art will envision other modifications within the scope and spirit of the claims appended thereto.

What is claimed is:

1. An intake manifold for receiving a gaseous material, the intake manifold comprising:
a main body defining an interior chamber; and
at least one wall protruding from the main body into the interior chamber; and
the main body comprising a first end, and an opening located at the first end and opening into the interior chamber,
wherein the at least one wall comprises a thickened portion located in the interior chamber.

2. The intake manifold of claim 1,
wherein the thickened portion of the at least one wall is located at an interior end portion of the wall.

3. The intake manifold of claim 2,
wherein the least one wall further comprises a tapered portion tapering in a direction from the thickened portion of the wall to the main body.

4. The intake manifold of claim 2,
wherein the thickened portion of the at least one wall is configured to facilitate a laminar flow of the gaseous material within the interior chamber.

5. The intake manifold of claim 2, wherein the thickened portion has a thickness in a range from approximately 0.34 inches (0.86 cm) to approximately 0.58 inches (1.47).

6. The intake manifold of claim 5, wherein the thickened portion has the thickness in the range from approximately 0.34 inches (0.86 cm) to approximately 0.58 inches (1.47) at a location spaced approximately 0.38 inches (0.95 cm) from the interior end portion of the wall.

7. The intake manifold of claim 2,
wherein the main body further comprises a second end opposite the first end, and
wherein the thickened portion of the at least one wall extends along approximately 50-70% of a length of the wall in a direction from the first end to the second end of the main body.

8. The intake manifold of claim 1,
wherein the at least one wall comprises a plurality of walls, and
wherein each of the walls comprises a thickened portion located in the interior chamber.

9. The intake manifold of claim 8,
wherein the thickened portion of each of the walls is located at an interior end portion of the wall.

10. The intake manifold of claim 9,
wherein each of the walls further comprises a tapered portion tapering in a direction from the thickened portion of the wall to the main body.

11. The intake manifold of claim 1,
wherein the opening has the general shape of a plurality of adjacent lobes, and
wherein the interior chamber comprises at least one sub-chamber, the at least one sub-chamber corresponding to a portion of the opening.

12. The intake manifold of claim 1,
wherein the lobes are arranged in the general shape of a four-leaf clover.

13. The intake manifold of claim 11,
wherein the at least one sub-chamber comprises four sub-chambers.

14. The intake manifold of claim 11,
wherein the at least one wall comprises a plurality of first walls,
wherein the at least one sub-chamber comprises a plurality of sub-chambers, and
wherein each of the first walls protrudes from the main body into a respective one of the sub-chambers.

15. The intake manifold of claim 14,
wherein the sub-chambers comprises at least three sub-chambers,
wherein the intake manifold further comprises a plurality of second walls,
wherein each of the second walls is located between a corresponding pair of adjacent ones of the at least three sub-chambers, and
wherein each of the second walls protrudes from the main body into the interior chamber.

16. The intake manifold of claim 15, wherein each of the second walls protrudes into the interior chamber less than each of the first walls protrudes into the interior chamber.

17. The intake manifold of claim 1,
wherein the interior chamber opens into each of a plurality of runners, and
wherein each of the walls at least partially defines entries from the interior chamber to each of a corresponding pair of adjacent ones of the runners.

18. The intake manifold of claim 17, wherein the entries to the runners are configured to facilitate a laminar flow of the gaseous material from the interior chamber to the runners.

19. The intake manifold of claim 1,
wherein the main body further comprises a second end opposite the first end, the second end defining a floor of the interior chamber, and
wherein the main body further comprises a protruding member located on the floor of the interior chamber.

20. The intake manifold of claim 19, wherein the protruding member is configured to facilitate a laminar flow of the gaseous material within the interior chamber.

21. The intake manifold of claim 19, wherein the protruding member has the general shape of a dome.

22. The intake manifold of claim 1, wherein the intake manifold is substantially formed of a plastic.

23. The intake manifold of claim 1, wherein the intake manifold is substantially formed of a metal.

24. The intake manifold of claim 1, wherein the first end of the main body is configured to abut a carburetor of an engine.

25. An intake manifold for receiving a gaseous material, the intake manifold comprising:
a main body defining an interior chamber; and
a plurality of first walls protruding from the main body into the interior chamber; and
the main body comprising a first end, and an opening located at the first end and opening into the interior chamber,
wherein the interior chamber opens into each of a plurality of runners,
wherein each of the first walls at least partially defines entries from the interior chamber to each of a corresponding pair of adjacent ones of the runners, and
wherein the entries to the runners are configured to facilitate a laminar flow of the gaseous material from the interior chamber to the runners.

26. The intake manifold of claim 25, further comprising:
a plurality of second walls, each of the second walls located generally between a corresponding pair of the first walls and protruding from the main body into the interior chamber.

27. The intake manifold of claim 26,
wherein one of the entries is located generally between one of the second walls and one first wall of its corresponding pair of the first walls, and
wherein the one of the entries is defined by the one of the second walls and the one first wall.

28. The intake manifold of claim 26,
wherein each of the second walls protrudes into the interior chamber less than each of the first walls protrudes into the interior chamber.
